(19) United States
(12) Patent Application Publication
(10) Pub. No.: US 2013/0153100 A1
(43) Pub. Date: Jun. 20, 2013

(54) TIRE WITH TREAD HAVING IMPROVED WET TRACTION

(71) Applicants: Olivier Piffard, Mauldin, SC (US); Cyril Guichon, Beauregard-Vendon (FR); Xavier Saintigny, Greenville, SC (US); Raymond Stubblefield, Greenville, SC (US)

(72) Inventors: Olivier Piffard, Mauldin, SC (US); Cyril Guichon, Beauregard-Vendon (FR); Xavier Saintigny, Greenville, SC (US); Raymond Stubblefield, Greenville, SC (US)

(21) Appl. No.: 13/713,762

(22) Filed: Dec. 13, 2012

Related U.S. Application Data
(60) Provisional application No. 61/570,597, filed on Dec. 14, 2011.

(51) Int. Cl. B60C 11/11

(52) U.S. Cl. CPC B60C 11/11
USPC 152/209.1

(57) ABSTRACT

The present invention provides a tire tread having a configuration and material properties that improve wet traction. In particular, the tread has a specified minimum threshold for chamfer density and a maximum level of complex shear modulus for the material that constitutes the tread in order to optimize the road friction coefficient (p) a tire tread experiences during a wet braking event. This results in better wet traction and a shorter stopping distance during the braking event.

### PRIORITY CLAIM

This application claims the benefit of previously filed U.S. Provisional Patent Application entitled “ Tire with Tread having Improved Wet Traction”, assigned U.S. Ser. No. 61/570,597, filed Dec. 14, 2011, and which is incorporated herein by reference in its entirety for all purposes.

### BACKGROUND OF THE INVENTION

1. Field of the Invention

The present invention provides a tire tread having a configuration and material properties that improve wet traction. In particular, the tread has a specified minimum threshold for chamfer density and a maximum level of complex shear modulus for the material that constitutes the tread in order to optimize the road friction coefficient (p) a tire tread experiences during a wet braking event. This results in better wet traction and a shorter stopping distance during the braking event.

2. Description of the Related Art

Tires are designed with treads that have a host of needed performances including wear, snow traction, hydroplaning resistance, rolling resistance and dry braking. One of the most important performances is wet braking. This allows the driver of a vehicle to stop a car to avoid a collision during wet conditions as is often the case during inclement weather. As can be imagined, a substantial amount of research has been done in this area to improve or maximize the wet traction of a tire. As a result, several mechanisms have been proven useful in this regard and have been implemented.

One method used to improve wet traction is adding sipes to a tread block or rib. Sipes are narrow slits that do no consume a significant amount of water or snow but are useful for providing extra biting edges which help grip the road. Unfortunately, adding sipes can also deleteriously affect the dry traction of a tire. For all season tires, which are intended to have relatively good traction in both snow and wet conditions as well as have good dry traction, adding sipes is not always a satisfactory tuning tool for improving wet traction because of the negative effect it can have on dry traction.

Yet another method used to improve wet traction is the addition of void in the tread, particularly grooves oriented in the circumferential direction of the tire. The prior art is replete with examples of attempts to optimize the use of grooves by sizing them and orienting them in particular ways in order to improve or maximize wet traction. Unfortunately, there is often some tradeoff, however small in some cases, between optimizing the use of grooves for snow traction versus wet traction. For example, the use of a groove design that has more lateral grooves tends to provide better snow traction than wet traction whereas a groove design that has more circumferential grooves than lateral grooves tends to provide better wet traction. Therefore, similar to the use of siping, adding grooves is not an ideal tuning tool for optimizing wet traction due to the negative impact it can have on snow traction.

A third way of improving wet traction that has been investigated is not related to the configuration of the tread, but to the material properties of the tread. One example of this is reducing the modulus of the mix of the tread. In other words, using a softer tread sometimes helps in improving wet traction. However, it has been observed that this technique is only effective for treads that are extremely rigid, as is the case for treads that lack voids such as racing tires that do not have sipes or grooves. While this may be tolerable for specialty tires like racing tires, it is not a suitable solution for tires where other performances such as snow traction or dry traction are also needed. Furthermore, it has been further observed that this method is not successful for many winter or all-season tires.

Accordingly, there is a need for method for improving the wet traction of a tire tread without deleteriously impacting snow traction or dry traction as well. It would also be useful if such a method used a practical combination of material properties and tread configuration.

### SUMMARY OF THE INVENTION

According to one embodiment of the present invention, a tread for a tire is provided that comprises one or more repeating pitches, each repeating pitch comprising tread elements that are defined by one or more lateral grooves. These tread elements further include leading and trailing edges adjacent said lateral grooves and adjacent sipes found within the tread elements. This tread has a weighted Chamfer Density (CD_{w}) of at least 15%, wherein a chamfer density (CD) for each of the one or more repeating pitches is:

$$CD = \frac{TPLCE}{TPLE} ,$$

where, for one repeating pitch, TPLCE is total projected length of the chamfered edges of one repeating pitch, TPLE is the total projected length of the lateral edges of one repeating pitch, and wherein the tread elements comprise a rubber composition based upon a diene elastomer, a plasticizing system and a cross-linking system, wherein the rubber composition has a shear modulus G* measured at 60° of less than 1.0 MPa.

In certain embodiments, the rubber composition also has a glass transition temperature of between −40° C. and −15° C. In other embodiments, there are between 2 and 5 different repeating pitches. In such a case, the individual pitches from each of the repeating pitch patterns alternate repeatedly or in a pattern along the circumference of the tire tread.

In certain embodiments, the chamfered edges are filleted or rounded. In other embodiments, the shear modulus G* measured at 60° C. is between 0.5 MPa and 0.9 MPa. In some cases, this G* is between 0.75 MPa and 0.85 MPa.

In yet other embodiments, the chamfer density is between 80% and 100% and may be 90%. In some cases, the tread elements are tread blocks.

According to another embodiment of the present invention, a tread for a tire is provided that comprises one or more repeating pitches, each repeating pitch comprising tread elements that are defined by one or more lateral grooves. These tread elements further include leading and trailing edges adjacent said lateral grooves and adjacent sipes found within the tread elements. This tread has a weighted Chamfer Density (CD_{w}) of at least 15%, wherein a chamfer density (CD) for each of the one or more repeating pitches is:

$$CD = \frac{TPLCE}{TPLE} ,$$

where, for one repeating pitch, TPLCE is total projected length of the chamfered edges of one repeating pitch, TPLE is the total projected length of the lateral edges of one repeating pitch, and wherein the contact surface of the tread elements comprise a rubber composition based upon a diene elastomer, a plasticizing system and a cross-linking system, wherein the rubber composition has a shear modulus G* measured at 60° of less than 1.0 MPa.

Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a graph showing the wet coefficient of friction versus contact pressure for materials having different complex shear moduli at 60° C.

FIG. 2 is a two dimensional finite element model of a tread block with a sipe.

FIG. 3 is a two dimensional finite element model of a tread block with a sipe having chamfers found on its trailing edges.

FIG. 4 shows the finite element model of FIG. 2 in a sheared state, approximating a braking event.

FIG. 5 shows the finite element model of FIG. 3 in a sheared state, approximating a braking event.

FIG. 6 is the footprint of tire according to one embodiment of the present invention showing several of its pitches.

FIG. 7 shows one of the pitches contained in FIG. 6 and further defines the footprint width, pitch length and the projected lengths of the lateral edges on the lateral or Y axis.

FIG. 8 is a top view of the pitch shown in FIG. 7 with dimensions for the lateral edges removed for enhanced clarity.

FIG. 9 is a sectional view of a tread block found in FIG. 8 taken along lines 8-8 thereof, showing that both the leading and trailing edges of the block are chamfered.

FIG. 10 is a top view of the pitch of FIG. 8 showing the dimensions for the chamfered edges of the tread blocks projected along the Y axis.

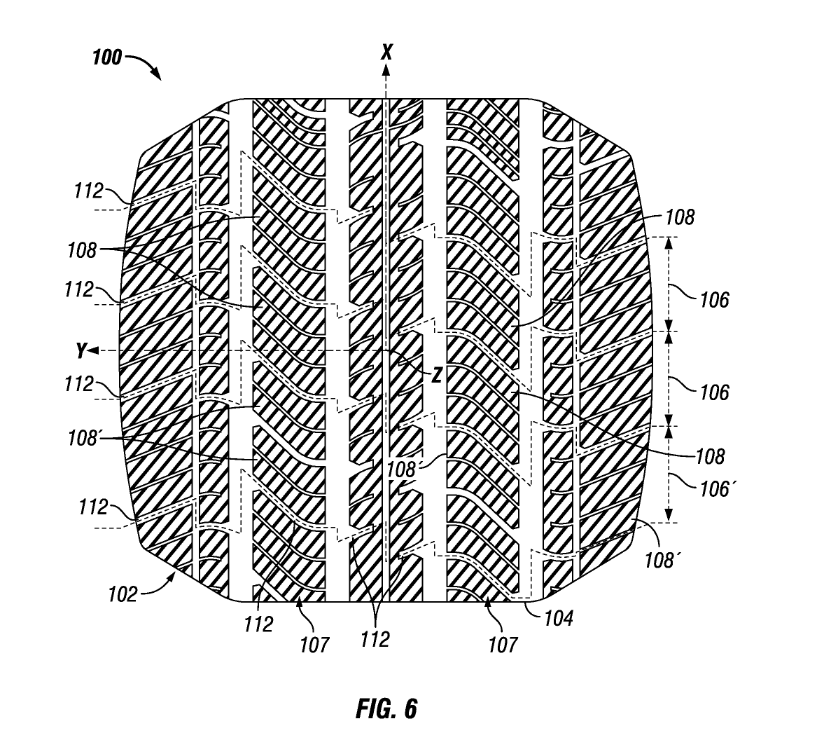

FIGS. 6 thru 10 are ink plots of the footprint of a tire that is under an operating load. It is to be understood, therefore; that the dimensions shown are slightly different than those of the tire in a non-deflected state. For the sake of clarity, all the values for the dimensions given that are associated with FIGS. 6 thru 10 are for the tire in a deflected state. For a passenger car, the measurements are taken for a footprint of a passenger car tire when said tire is loaded at 85% of the maximum load as marked on the tire sidewall at an inflation pressure of 35 psig. For a light truck tire, the measurements are taken for a footprint of a passenger car tire when said tire is loaded at 85% of the maximum load (single) as shown on the tire sidewall at the associated inflation pressure as marked on the tire sidewall.

### DETAILED DESCRIPTION OF THE REPRESENTATIVE EMBODIMENTS

Reference will now be made in detail to embodiments of the invention, one or more examples of which are illustrated in the Figures. Each example is provided by way of explanation of the invention, and not meant as a limitation of the invention. For example, features illustrated or described as part of one embodiment can be used with another embodiment to yield still a third embodiment. It is intended that the present invention include these and other modifications and variations. It should be noted that for the purposes of discussion, only a portion of the exemplary tire embodiments may be depicted in one or more of the figures. Reference numbers are used in the Figures solely to aid the reader in identifying the various elements and are not intended to introduce any limiting distinctions among the embodiments. Common or similar numbering for one embodiment indicates a similar element in the other embodiments.

As used herein, the “longitudinal” or X direction is in the tire circumferential direction and is perpendicular to the tire axis of rotation.

As used herein, the “lateral” or Y direction is along the tire width and is substantially parallel to the axis of rotation. However, as used herein, a “lateral groove” is any groove generally oriented at an angle less than 45 degrees with the purely lateral direction while a “longitudinal groove” is any groove generally oriented at an angle greater than or equal to 45 degrees with the purely lateral direction.

As used herein, the “radial” or Z direction is the radial direction of the tire to which a tread is attached in use.

As used herein, a “tread element” is any type or shape of structural feature found in the tread that contacts the ground. Examples of tread elements include tread blocks and tread ribs.

As used herein, a “tread block” is a tread element that has a perimeter defined by one or more grooves, creating an isolated structure in the tread.

As used herein, a “rib” is a tread element that runs substantially in the longitudinal direction of the tire and is not completely interrupted by any grooves that run in a substantially lateral direction or any other grooves oblique thereto.

As used herein, a “sipe” is a small slit that is molded or otherwise formed in a tread block or rib. A sipe may be straight, curved or otherwise formed in any geometrical shape.

As used herein, a “pitch” is a defined geometrical pattern that extends across the lateral width of the tread and is a member of the plurality of individual pitches that are disposed longitudinally along the entire tread length. Often, pitches are formed by identical mold components that are repeated about the circumference of a mold that forms the tire tread.

As used herein, a “repeating pitch” is a geometrical pattern that is repeated along the circumference of the tread and extends across the lateral width of the tread. A tire may have one or more repeating pitches. When there is more than one repeating pitch, the different repeating pitches are often disposed so as to alternate with the others along the tread in some repeating pattern.

As used herein, “phr” is “parts per hundred parts of rubber by weight” and is a common measurement in the art wherein components of a rubber composition are measured relative to the total weight of rubber in the composition, i.e., parts by weight of the component per 100 parts by weight of the total rubber(s) in the composition.

As used herein, elastomer and rubber are synonymous terms.

As used herein, “based upon” is a term recognizing that embodiments of the present invention are made of vulcanized or cured rubber compositions that were, at the time of their assembly, uncured. The cured rubber composition is therefore “based upon” the uncured rubber composition. In other words, the cross-linked rubber composition is based upon or comprises the constituents of the cross-linkable rubber composition.

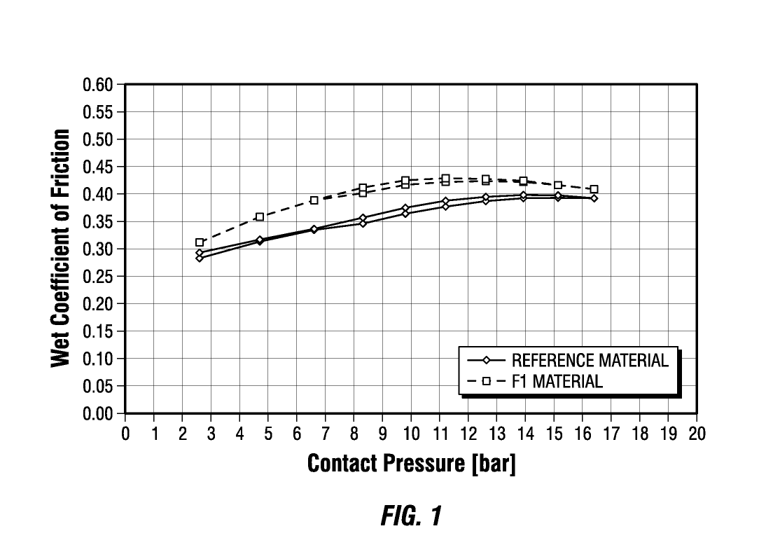

Research conducted by the inventors has revealed that the reason using a material with a lower modulus does not always improve wet traction is related to the relationship between the material of the tread and the road friction coefficient (μ) that is developed between the tread and the road surface at different times and in different conditions. That is to say, this relationship is not constant and is in fact a function of the pressure exerted on the tread. FIG. 1 shows this relationship graphically for two materials tested by the inventors.

Looking at FIG. 1, one can see that the bottom curve is related to a reference material that has material constituents as listed in table 1 below including a BR content of 42.5 phr, a SBR content of 63.25 phr, a first plasticizer content in the form of napthenic oil of 10.3 phr, and a second plasticizer content in the form of polyterpene resin of 15 phr. It has material properties as listed below in table 1 including a complex shear modulus G* at 60 degrees Celsius of approximately 1.37 MPa when subjected to a 0.7 MPa stress, a glass transition temperature of −21 degrees Celsius at MDC, and a shore A hardness of 57.

This material was tested on a rubber sample that was slid on an asphalt surface at 0.5 meters per second speed at 35 degrees Celsius and the wet coefficient of friction (μ) was calculated as a function of contact pressure. Two runs were conducted and are plotted to show that the results are repeatable. As can be seen, the maximum for μ occurred at 14 to 15 bars of pressure. For reasons explained more thoroughly later, the inventors realized that this curve was not optimal for wet braking.

TABLE 1
Formulations/Properties

| Formulations | Ref. | F1 | F2 | F3 |
|---|---|---|---|---|
| BR (phr) | 42.5 | 46.5 | 46.5 | 49.5 |
| SBR (phr) | 63.25 | 58.85 | 58.85 | 55.55 |
| Silica (phr) | 75 | 75 | 75 | 75 |
| Naphthenic Oil (phr) | 10.3 | 16.5 | 6.2 | 6.5 |
| Sunflower Oil (phr) | 0 | 0 | 0 | 12.8 |
| Polyterpene Resin (phr) | 15 | 26.4 | 39.7 | 22.4 |
| Silane Coupling Agent (phr) | 12 | 12 | 12 | 12 |
| Additives (Wax & 6PPD) (phr) | 3.4 | 3.4 | 3.4 | 3.4 |
| Curing Package (phr) | 8 | 8 | 8 | 8 |
| Physical Properties tested at a | | | | |
| solicitation stress of .7 MPa | | | | |
| MA10 @ 23° C. | 5.5 | 2.61 | 2.97 | 2.45 |
| Modulus G* @ 60° C. (MPa) | 1.37 | 0.79 | 0.84 | 0.82 |
| Tan Delta Max @ 23° C. | .32 | .26 | .33 | .26 |
| Tg, ° C. MDC | −21 | −21 | −14 | −31 |
| Shore Hardness A | 67 | 57 | 59 | 57 |

The second material on the graph which corresponds to formulation F1, which is one that has a complex shear modulus of G* at 60 degrees Celsius of less than 1 MPa according to an embodiment of the present invention. Its constituents and properties are designated under the column for F1 in Table 1. It has a higher BR content of 46.5 phr than the reference material, a lower SBR content of 58.86 phr than the reference material, a higher content of napthenic oil of 16.5 phr and a much higher content of polyterpene resin of 26.4 phr than the reference material. It has material properties as listed in the lower portion of table 1 including a complex modulus G* at 60 degrees Celsius of approximately 0.79 MPa when subjected to a 0.7 MPa stress, a glass transition temperature of −21 degrees Celsius at MDC, and a shore A hardness of 57.

This material was also tested using a rubber sample that was slid on an asphalt surface at 0.5 meters per second speed at 35 degrees Celsius and the wet coefficient of friction (μ) was calculated as a function of contact pressure. As can be seen, the maximum for μ occurred at 11 bars of pressure. Again, two runs were conducted and plotted to show that the results were repeatable. For reasons explained more thoroughly later, the inventors realized that this curve was more optimal for wet braking. This change is directly related in part to the modulus of the material.

Overall, the wet coefficient of friction has increased by an average of 10% over the measured pressure range by lowering the modulus and the peak of the coefficient of friction has moved from occurring at 14-15 bars for the reference material to 11 bars for formulation F1. This shift provides further advantages when one considers the pressures a tread block, rib or other type of tread element experiences when it is involved in a wet breaking event. The inventors realized that these pressures are somewhat related to tread geometry or sculpture in addition to the complex shear modulus and this has been theoretically proven as provided below.

Further research performed by the inventors of the present invention via 2D finite element simulation such as ABAQUS has shown that the peak pressure on the leading edge of a tread block is a function of the conditions in which an event, such as a braking event, occurs and the geometry of the tread block or rib. Particularly, the peak pressure on the leading edge of a tread block is typically much lower than 15 bars, especially when the tread block is very pliable. On the other hand, when a material having a lower rigidity, such as F1, is subjected to such a high pressure, the road friction coefficient (μ) is less than the maximum available for that particular material. Accordingly, the inventors recognized that in order to reach the maximum available road friction coefficient (μ) for a wet braking event, then the pressure near the edge of a tread block needed to be decreased. This in combination with the lower rigidity of the material, as is the case with formulation F1, would provide the most optimal solution.

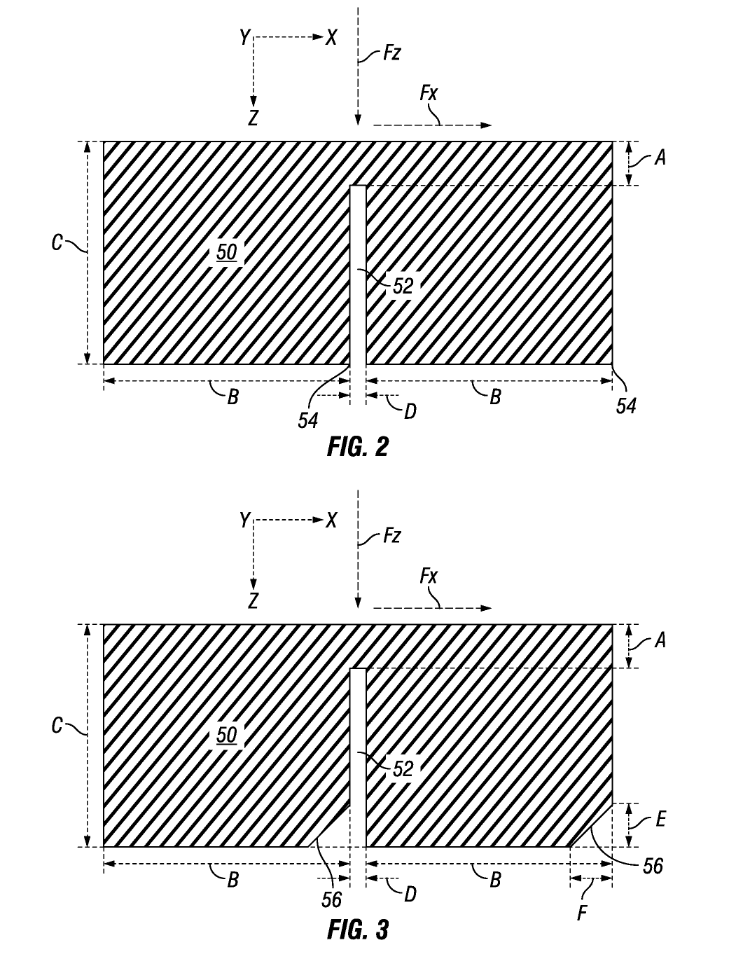

Looking at FIG. 2, a 2D model of a tread rib or block 50 with a sipe 52 therein was modeled using ABAQUS having a vertical force Fz in the radial or Z direction, a horizontal or circumferential force Fx, which would be the force in the circumferential X or rolling direction of the tire, applied to it. This model also includes other dimensions including B, which is the block length in the X direction, C which is the height of the block or rib in the Z direction, D which is the thickness of the sipe in the X direction, and A which is the distance from the bottom of the sipe to the bottommost extent of the block or rib in the Z direction. There are no chamfers on this model on the leading edges 54 of the block.

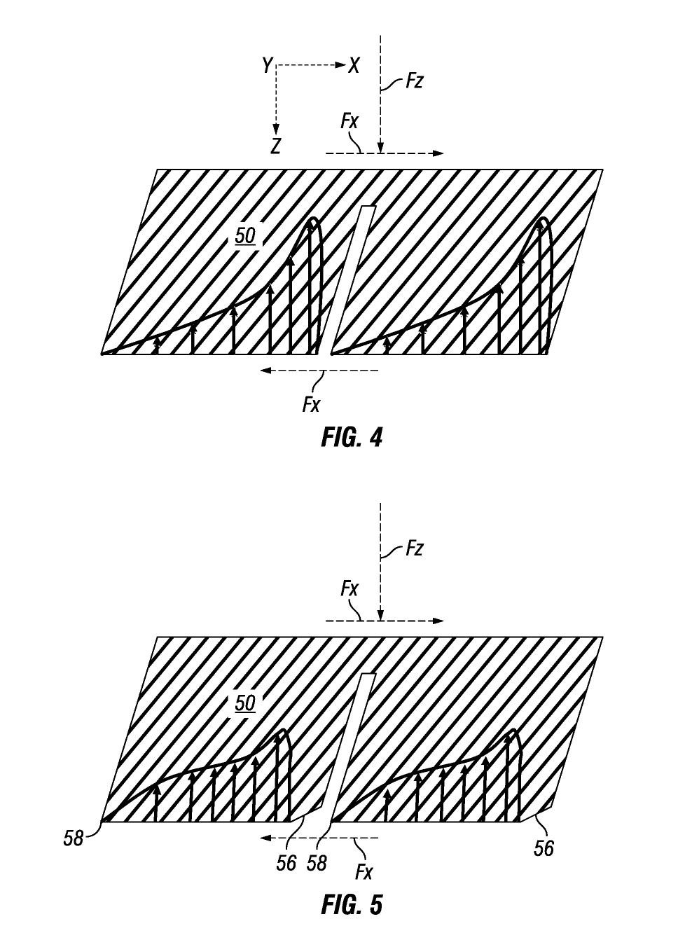

FIG. 3, on the other hand, shows a similarly dimensioned and modeled tread block or rib except that chamfers 56 with a horizontal dimension of F and a vertical dimension of E have been added to the leading edge 54 of the block or rib, so called because it is the first edge to contact the ground as the tire rotates and enter into the contact patch. For this model, E and F were both 1 mm.

FIG. 4, depicts the model shown in FIG. 2 under a braking solicitation that causes the tread element to shear. Under a braking solicitation, this figure shows that the pressure distribution experienced by a tread element such as a block or rib near is in fact not uniform and is highest near the leading edge or trailing edge of the block or tread element and lowest in the center of the block or rib. Other examples of this phenomenon are well known in the art. As mentioned above, this could reduce the effectiveness of wet braking for such a block as the coefficient of wet friction is higher at lower pressures.

FIG. 5, on the other hand, shows the model in FIG. 3 under a similar breaking solicitation. Now, the trailing edge, which is chamfered, shows a reduced pressure locally which is more ideal for maximizing the coefficient of wet breaking friction. Put into other words, the peak edge pressure will decrease if a chamfer or filleted edge is placed on the leading block edge. As can be seen, the peak pressure experienced on the leading edge is a function of tread block geometry, rubber to ground coefficient of friction and the material modulus. Hence, a synergistic improvement can be created especially by adding chamfers and decreasing the modulus of the material locally near the leading edge of the tread element. A similar effect can be achieved near the trailing edge 58, which is on opposing side of a tread block or rib as compared to the leading edge and is so called because it the last edge to exit the contact patch as the tire rolls.

Surprisingly, such a design does not deleteriously affect snow traction and the snow and wet traction compromise can be broken by combining a soft material with the use of chamfers.

Design iterations on a tread using various chamfer configurations and densities were performed. It was found a chamfer having a 1 mm depth and 1 mm length that was used frequently could lower the peak pressure exerted on a tread block edge during a wet braking event, which in turn, allowed the maximum road friction coefficient (μ) to be achieved for a particular material. The frequency that the chamfers should be used is called the chamfer density and it should be greater than 15% in order to gain significantly from the use of the chamfers and may preferably approach 100%. Similarly, the complex shear modulus (G*@60 deg C.) of the material should be less than 1 MPa. Accordingly, formulations F2 and F3 listed in table 1 are also considered within the scope of the present invention but were left off the graph of FIG. 1 to enhance the clarity of the graph. They would also shift the maximum coefficient of friction upwardly and to the left of the reference material as shown in FIG. 1.

The chamfer density of a tread sculpture is computed as follows. Turning to FIG. 6, a footprint 100 of a tire according to an embodiment of the present invention is shown. By footprint, it is meant the area of contact between the tire and ground or road surface as the tire rolls. Its area excludes those areas that do not actually touch the road or ground. Therefore, a footprint 100 is defined by the meandering perimeter of each tread element of the tread shown there. So, its area is equivalent to the area shown that is cross-hatched. By contrast, the contact patch 102 is defined by the outside perimeter of the area shown in FIG. 6 designated by line 104 and is not defined by the amount of void found within the footprint.

The footprint includes several pitches. By pitch 106, it is meant a repetitious geometrical pattern of a tire tread that is arranged in a circular array about the circumference of a tire. In many instances, these pitches are molded using identical mold components that are also arranged in a circular array about the circumference of a mold that forms and cures the geometry of the tire tread. In some cases, the tread pattern of a tire can be composed of multiple unique geometrical patterns or pitches that are each duplicated around the circumference of the tire as is the case here. Note that a first pitch 106 is repeated twice and is adjacent another pitch 106′. This difference between pitches is most noticeable by looking at the presence of two tread blocks 108′ in the intermediate rows 107 of tread blocks of pitch 106′ while a single tread block 108 is in the same position for pitch 106. This 2-1 pattern is repeated around the circumference of the tire.

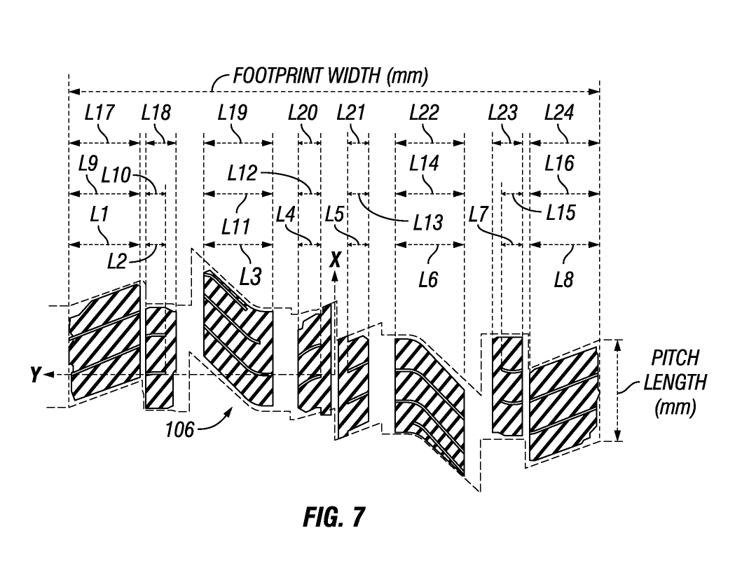

Focusing now on FIG. 7, pitch 106 is displayed by itself and dimensions L1 thru L8 represent the individual lengths of each lateral groove 112 (lateral grooves are best seen in FIG. 6) that has been projected onto the lateral or Y axis along the entire footprint width. In this case, there are lateral grooves formed on the leading and trailing edges of the pitch. Dimensions L9 thru L16 represent the individual lengths of each sipe that is part of a first set of sipes that are substantially aligned in the X direction located closest to the trailing edge of the pitch. Finally, dimensions L17 thru L24 represent the individual lengths of the second set of sipes that are substantially aligned in the X direction located closest to the leading edge of the pitch. Since it is desirous to find the Total Projected Length of the Lateral Edges (TPLE) for a pitch, and since each lateral void L almost always has two edges, such as a leading edge and a trailing edge, the TPLE can be calculated by summing up the individual lengths of the voids and multiplying by two to get the appropriate value. This can be calculated as follows using equation 1:

$$TPLE = 2 \times ( {\sum }_{i = 1}^{N} {L}_{i} ) . \qquad ( Eq . 1 )$$

For example, when there are twenty-four individual lengths of voids, as is the case here, L1 thru L24 would be summed up and then multiplied by two. The units would be in length such as millimeters.

In some cases, where the tread pattern is composed of different pitches, then the tread pattern total projected length of the lateral edges is the weighted average of each pitch total projected length of the lateral edges (TPLE_{w}) of the tread pattern. The weighing is based on the circumference percentage of a given pitch around the tread pattern. For example, in the situation where there are three different pitches used about the circumference of the tire, the weighted average may be computed using equation 2 below:

$${TPLE}_{w} = \frac{( {\sum }_{i = 1}^{n} ( {TPLE}_{i} \times {NP}_{i} \times {PL}_{i} ) )}{{\sum }_{i = 1}^{n} ( {NP}_{i} \times {PL}_{i} )} . \qquad Eq . 2$$

When there are three different pitches being used, then TPLE_{w} is calculated as follows using the following data:
Length of Pitch 1: PL₁
Number of Pitch 1: NP₁
Pitch 1 Total Projected Length of Lateral Edges: TPLE₁ as calculated using Eq. 1
Length of Pitch 2: PL₂
Number of Pitch 2: NP₂
Pitch 2 Total Projected Length of Lateral Edges: TPLE₂ as calculated using Eq. 1
Length of Pitch 3: PL₃
Number of Pitch 3: NP₃
Pitch 3 Total Projected Length of Lateral Edges: TPLE₃ as calculated using Eq. 1, and equation 2 becomes:

$${TPLE}_{w} = \frac{{TPLE}_{1} \times {NP}_{1} \times {PL}_{1} + {TPLE}_{2} \times {NP}_{2} \times {PL}_{2} + {TPLE}_{3} \times {NP}_{3} \times {PL}_{3}}{{NP}_{1} \times {PL}_{1} + {NP}_{2} \times {PL}_{2} + {NP}_{3} \times {PL}_{3}} .$$

By way of further example, when these variables having the following values: PL₁=35 mm, NP₁=20, TPLE₁=50, PL₂=30 mm, NP₂=25, TPLE₂=60, PL₃=25 mm, NP₃=30, TPLE₃=70; then the weighted TPLE_{w} is calculated to be 60.23 mm. Of course, equation 2 reduces to equation 1 when only one type of pitch is used about the circumference of the tire tread.

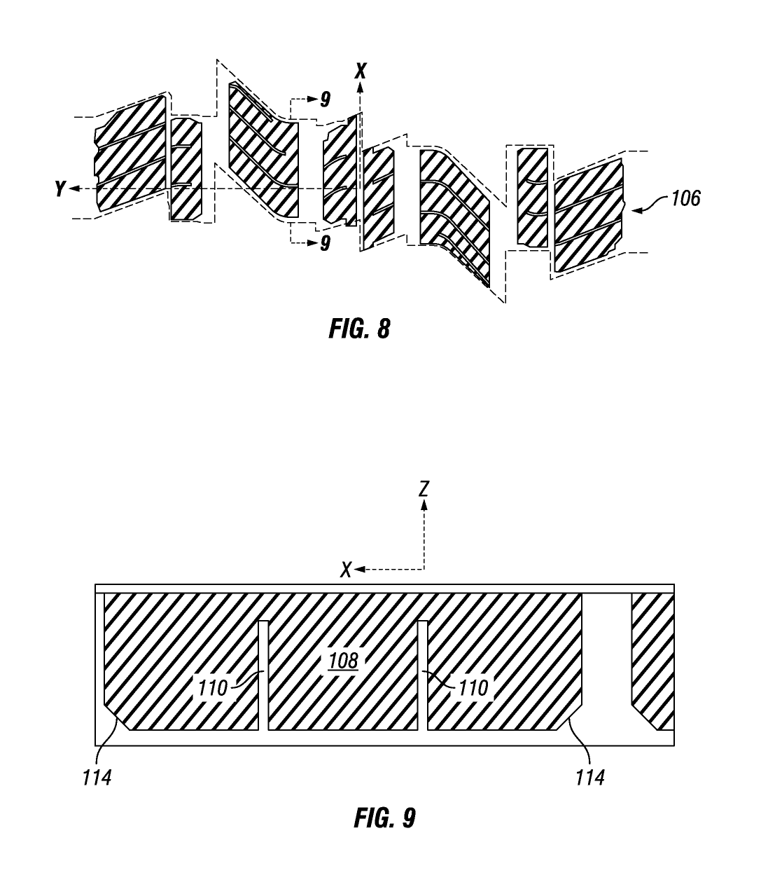

Turning now to FIGS. 8 and 9, pitch 106 is displayed in such a way that chamfers 114 are located on the leading and trailing edges of all the tread blocks 108 for this pitch. This is advantageous as it decreases the pressure during a braking event at both sets of edges. As shown, there are two sipes 110 found within the tread block that are not chamfered.

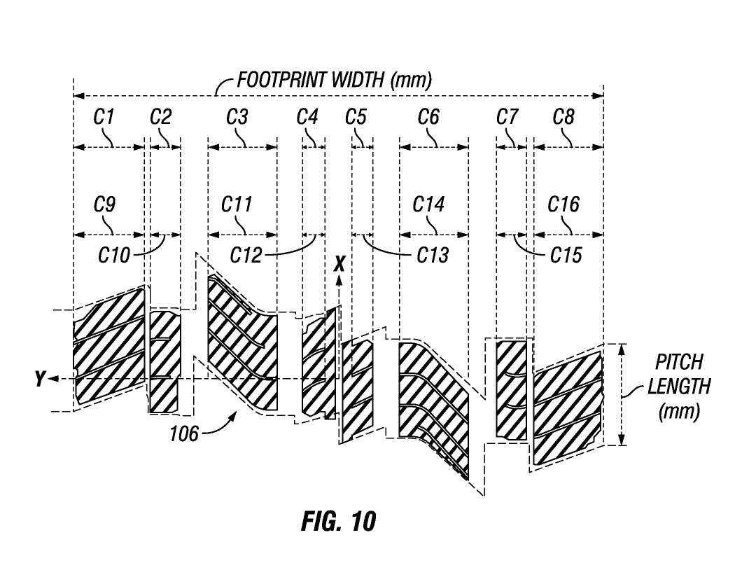

FIG. 10, shows how the Total Projected Length of the Chamfer Edges (TPLCE) is calculated. It should be noted that dimensions C1 thru C8 represent the individual lengths of each chamfer that has been projected onto the lateral or Y axis along the entire footprint width along the lateral void that is found along the trailing edge of the pitch whereas dimensions C9 thru C16 represent the individual lengths of each chamfer that has been projected onto the Y axis adjacent the lateral void that is found along the leading edge of the pitch. It is contemplated that additional chamfered edges could be used on the sipes but that is not the case here as only the lateral grooves are chamfered. The Total Projected Length of the Chamfer Edges (TPLCE) for a pitch can be calculated by summing up the individual lengths. This can be calculated as follows using equation 3:

$$TPLCE = ( {\sum }_{i = 1}^{N} {C}_{i} ) . \qquad ( Eq . 3 )$$

For example, when there are sixteen individual lengths, as is the case here, C1 thru C16 would be summed up. The units would be in length such as millimeters. It should be noted that this equation adds up each chamfer edge individually, as such, no multiplication factor is needed as was the case for equation 1.

In some cases, where the tread pattern is composed of different pitches, then the tread pattern Total Projected Length of the Chamfers (TPLCE) is the weighted average of each Total Projected Length of the Chamfers (TPLCE_{w}) of the tread pattern. The weighing is based on the circumference percentage of a given pitch around the tread pattern. For example, in the situation where there are three different pitches used about the circumference of the tire, the weighted average may be computed using equation 4 below:

$${TPLCE}_{w} = \frac{( {\sum }_{i = 1}^{n} ( {TPLCE}_{i} \times {NP}_{i} \times {PL}_{i} ) )}{{\sum }_{i = 1}^{n} ( {NP}_{i} \times {PL}_{i} )} . \qquad Eq . 4$$

When there are three different pitches being used, then TPLCE_{w} is calculated as follows using the following data:
Length of Pitch 1: PL₁
Number of Pitch 1: NP₁
Pitch 1 Total Projected Length of Chamfer Edges: TPLCE₁ as calculated using Eq. 3
Length of Pitch 2: PL₂
Number of Pitch 2: NP₂
Pitch 2 Total Projected Length of Chamfer Edges: TPLCE₂ as calculated using Eq. 3
Length of Pitch 3: PL₃
Number of Pitch 3: NP₃
Pitch 3 Total Projected Length of Chamfer Edges: TPLCE₃ as calculated using Eq. 3, and equation 4 becomes:

$${TPLCE}_{w} = \frac{{TPLCE}_{1} \times {NP}_{1} \times {PL}_{1} + {TPLCE}_{2} \times {NP}_{2} \times {PL}_{2} + {TPLCE}_{3} \times {NP}_{3} \times {PL}_{3}}{{NP}_{1} \times {PL}_{1} + {NP}_{2} \times {PL}_{2} + {NP}_{3} \times {PL}_{3}} .$$

By way of further example, when these variables having the following values: PL₁=35 mm, NP₁=20, TPLCE₁=50, PL₂=30 mm, NP₂=25, TPLCE₂=60, PL₃=25 mm, NP₃=30, TPLCE₃=70; then the weighted TPLCE_{w} is calculated to be 60.23 mm. Of course, equation 4 reduces to equation 3 when only one pitch type is used around the circumference of the tire tread.

Once the values for TPLE and TPLCE have been calculated, then finally the Chamfer Density (CD) can be calculated by dividing TPLCE by the TPLE. This calculation is represented below by equation 5:

$$CD = \frac{TPLCE}{TPLE} . \qquad Eq . 5$$

In cases where multiple pitches are used, then the Chamfer Density equals the quantity of the weighted Total Projected Length of the Chamfer Edges (TPLCE_{w}) divided by the Total Projected Length of the Lateral Grooves (TPLE_{w}). This is represented below by equation 6:

$${CD}_{w} = \frac{{TPLCE}_{w}}{{TPLE}_{w}} . \qquad Eq . 6$$

Of course, equation 6 reduces to equation 5 when only one pitch type is used about the circumference of the tire tread.

As has been noted, particular embodiments of the present invention surprisingly break the compromise between the wet and snow traction through a unique combination of materials and sculpture design. The sculpture design has been discussed above and it has been disclosed that such sculptures provide a desirable weighted chamfer density. In addition to this sculpture configuration, the materials component of the tire treads that break the compromise between wet and snow traction includes forming the treads from a rubber composition having a suitably low complex modulus at 60 degrees C. The discussion below will detail suitable compositions for making the treads.

Such suitable compositions include those rubber compositions having a complex modulus within a defined range and that are based upon a diene elastomer, a plasticizing system and a cross-linking system. The diene elastomers or rubbers that are useful for such rubber compositions are understood to be those elastomers resulting at least in part, i.e., a homopolymer or a copolymer, from diene monomers, i.e., monomers having two double carbon-carbon bonds, whether conjugated or not.

These diene elastomers may be classified as either “essentially unsaturated” diene elastomers or “essentially saturated” diene elastomers. As used herein, essentially unsaturated diene elastomers are diene elastomers resulting at least in part from conjugated diene monomers, the essentially unsaturated diene elastomers having a content of such members or units of diene origin (conjugated dienes) that is at least 15 mol. %. Within the category of essentially unsaturated diene elastomers are highly unsaturated diene elastomers, which are diene elastomers having a content of units of diene origin (conjugated diene) that is greater than 50 mol. %.

Those diene elastomers that do not fall into the definition of being essentially unsaturated are, therefore, the essentially saturated diene elastomers. Such elastomers include, for example, butyl rubbers and copolymers of dienes and of alpha-olefins of the EPDM type. These diene elastomers have low or very low content of units of diene origin (conjugated dienes), such content being less than 15 mol. %.

Examples of suitable conjugated dienes include, in particular, 1,3-butadiene, 2-methyl-1,3-butadiene, 2,3-di(C₁-C₅ alkyl)-1,3-butadienes such as, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Examples of vinyl-aromatic compounds include styrene, ortho-, meta- and para-methylstyrene, the commercial mixture “vinyltoluene”, para-tert-butylstyrene, methoxystyrenes, chloro-styrenes, vinylmesitylene, divinylbenzene and vinylnaphthalene.

The copolymers may contain between 99 wt. % and 20 wt. % of diene units and between 1 wt. % and 80 wt. % of vinyl-aromatic units. The elastomers may have any microstructure, which is a function of the polymerization conditions used, in particular of the presence or absence of a modifying and/or randomizing agent and the quantities of modifying and/or randomizing agent used. The elastomers may, for example, be block, random, sequential or micro-sequential elastomers, and may be prepared in dispersion or in solution; they may be coupled and/or starred or alternatively functionalized with a coupling and/or starring or functionalizing agent.

Examples of suitable diene elastomers include polybutadienes, particularly those having a content of 1,2-units of between 4 mol. % and 80 mol. % or those having a cis-1,4 content of more than 80 mol. %. Also included are polyisoprenes and butadiene/styrene copolymers, particularly those having a styrene content of between 5 wt. % and 50 wt. % or of between 20 wt. % and 40 wt. % and in the butadiene faction, a content of 1,2-bonds of between 4 mol. % and 65 mol. %, a content of trans-1,4 bonds of between 20 mol. % and 80 mol. %. Also included are butadiene/isoprene copolymers, particularly those having an isoprene content of between 5 wt. % and 90 wt. % and a glass transition temperature (Tg, measured in accordance with ASTM D3418) of −40° C. to −80° C.

Further included are isoprene/styrene copolymers, particularly those having a styrene content of between 5 wt. % and 50 wt. % and a Tg of between −25° C. and −50° C. In the case of butadiene/styrene/isoprene copolymers, examples of those which are suitable include those having a styrene content of between 5 wt. % and 50 wt. % and more particularly between 10 wt. % and 40 wt. %, an isoprene content of between 15 wt. % and 60 wt. %, and more particularly between 20 wt. % and 50 wt. %, a butadiene content of between 5 wt. % and 50 wt. % and more particularly between 20 wt. % and 40 wt. %, a content of 1,2-units of the butadiene fraction of between 4 wt. % and 85 wt. %, a content of trans-1,4 units of the butadiene fraction of between 6 wt. % and 80 wt. %, a content of 1,2-plus 3,4-units of the isoprene fraction of between 5 wt. % and 70 wt. %, and a content of trans-1,4 units of the isoprene fraction of between 10 wt. % and 50 wt. %, and more generally any butadiene/styrene/isoprene copolymer having a Tg of between −20° C. and −70° C.

The diene elastomers used in particular embodiments of the present invention may further be functionalized, i.e., appended with active moieties. Examples of functionalized elastomers include silanol end-functionalized elastomers that are well known in the industry. Examples of such materials and their methods of making may be found in U.S. Pat. No. 6,013,718, issued Jan. 11, 2000, which is hereby fully incorporated by reference.

The silanol end-functionalized SBR used in particular embodiments of the present invention may be characterized as having a glass transition temperature Tg of between −50° C. and −10° C. or alternatively between −40° C. and −15° C. or between −30° C. and −20° C. as determined by differential scanning calorimetry (DSC) according to ASTM E1356. The styrene content, for example, may be between 15% and 30% by weight or alternatively between 20% and 30% by weight with the vinyl content of the butadiene part, for example, being between 25% and 70% or alternatively, between 40% and 65% or between 50% and 60%.

In summary, suitable diene elastomers for particular embodiments of the present invention include highly unsaturated diene elastomers such as polybutadienes (BR), polyisoprenes (IR), natural rubber (NR), butadiene copolymers, isoprene copolymers and mixtures of these elastomers. Such copolymers include butadiene/styrene copolymers (SBR), isoprene/butadiene copolymers (BIR), isoprene/styrene copolymers (SIR) and isoprene/butadiene/styrene copolymers (SBIR). Such elastomers may also include any of these being functionalized elastomers.

Particular embodiments of the present invention may contain only one diene elastomer and/or a mixture of several diene elastomers. While some embodiments are limited only to the use of one or more highly unsaturated diene elastomers, other embodiments may include the use of diene elastomers mixed with any type of synthetic elastomer other than a diene elastomer or even with polymers other than elastomers as, for example, thermoplastic polymers.

In addition to the rubber, the rubber composition disclosed herein may further include a reinforcing filler. Reinforcing fillers are added to rubber compositions to, inter alia, improve their tensile strength and wear resistance. Any suitable reinforcing filler may be suitable for use in compositions disclosed herein including, for example, carbon blacks and/or inorganic reinforcing fillers such as silica, with which a coupling agent is typically associated.

Suitable carbon blacks include, for example, those of the type HAF, ISAF and SAF, conventionally used in tires. Reinforcing blacks of ASTM grade series 100, 200 and/or 300 are suitable such as, for example, the blacks N115, N134, N234, N330, N339, N347, N375 or alternatively, depending on the intended application, blacks of higher ASTM grade series such as N660, N683 and N772.

Inorganic reinforcing fillers include any inorganic or mineral fillers, whatever its color or origin (natural or synthetic), that are capable without any other means, other than an intermediate coupling agent, or reinforcing a rubber composition intended for the manufacture of tires. Such inorganic reinforcing fillers can replace conventional tire-grade carbon blacks, in whole or in part, in a rubber composition intended for the manufacture of tires. Typically such fillers may be characterized as having the presence of hydroxyl (—OH) groups on its surface.

Inorganic reinforcing fillers may take many useful forms including, for example, as powder, microbeads, granules, balls and/or any other suitable form as well as mixtures thereof. Examples of suitable inorganic reinforcing fillers include mineral fillers of the siliceous type, such as silica (SiO₂), of the aluminous type, such as alumina (AlO₃) or combinations thereof.

Useful silica reinforcing fillers known in the art include fumed, precipitated and/or highly dispersible silica (known as “HD” silica). Examples of highly dispersible silicas include Ultrasil 7000 and Ultrasil 7005 from Degussa, the silicas Zeosil 1165MP, 1135MP and 1115MP from Rhodia, the silica Hi-Sil EZ150G from PPG and the silicas Zeopol 8715, 8745 and 8755 from Huber. In particular embodiments, the silica may have a BET surface area, for example, of between 60 m²/g and 250 m²/g or alternatively between 80 m²/g and 230 m²/g.

Examples of useful reinforcing aluminas are the aluminas Baikalox A125 or CR125 from Baikowski, APA-100RDX from Condea, Aluminoxid C from Degussa or AKP-G015 from Sumitomo Chemicals.

For coupling the inorganic reinforcing filler to the diene elastomer, a coupling agent that is at least bifunctional provides a sufficient chemical and/or physical connection between the inorganic reinforcement filler and the diene elastomer. Examples of such coupling agents include bifunctional organosilanes or polyorganosiloxanes. Such coupling agents and their use are well known in the art. The coupling agent may optionally be grafted beforehand onto the diene elastomer or onto the inorganic reinforcing filler as is known. Otherwise it may be mixed into the rubber composition in its free or non-grafted state. One useful coupling agent is X 50-S, a 50-50 blend by weight of Si69 (the active ingredient) and N330 carbon black, available from Evonik Degussa.

In the rubber compositions according to the invention, the content of coupling agent is preferably between 2 and 15 phr, more preferably between 4 and 12 phr (for example between 3 and 8 phr). However, it is generally desirable to minimize its use. The amount of coupling agent typically represents between 0.5 and 15 wt. % relative to the total weight of the reinforcing inorganic filler. In the case for example of tire treads for passenger vehicles, the coupling agent may be less than 12 wt. % or even less than 10 wt. % relative to the total weight of reinforcing inorganic filler.

In particular embodiments, the amount of total reinforcing filler (carbon black and/or reinforcing inorganic filler) is between 20 phr and 200 phr or alternatively between 30 phr and 150 phr or between 50 phr and 110 phr.

In addition to the diene elastomer and reinforcing filler, particular embodiments of the rubber composition disclosed herein may further include a plasticizing system. The plasticizing system may provide both an improvement to the processability of the rubber mix and/or a means for adjusting the rubber composition's glass transition temperature and/or rigidity. Suitable plasticizing systems may include a processing oil, plasticizing resin or combinations thereof.

Suitable processing oils may include those derived from petroleum stocks, those having a vegetable base and combinations thereof. Examples of oils that are petroleum based include aromatic oils, paraffinic oils, naphthenic oils, MES oils, TDAE oils and so forth as known in the industry.

Examples of suitable vegetable oils include sunflower oil, soybean oil, safflower oil, corn oil, linseed oil and cotton seed oil. These oils and other such vegetable oils may be used singularly or in combination. In some embodiments, sunflower oil having an high oleic acid content (at least 70 weight percent or alternatively, at least 80 weight percent) is useful, an example being AGRI-PURE 80, available from Cargill with offices in Minneapolis, Minn.

A plasticizing hydrocarbon resin is a hydrocarbon compound that is solid at ambient temperature (e.g., 23° C.) as opposed to a liquid plasticizing compound, such as a plasticizing oil. Additionally a plasticizing hydrocarbon resin is compatible, i.e., miscible, with the rubber composition with which the resin is mixed at a concentration that allows the resin to act as a true thinning agent, e.g., at a concentration that is typically at least 5 phr (parts per hundred parts rubber by weight) or even much higher.

Plasticizing hydrocarbon resins are polymers that can be aliphatic, aromatic or combinations of these types, meaning that the polymeric base of the resin may be formed from aliphatic and/or aromatic monomers. These resins can be natural or synthetic materials and can be petroleum based, in which case the resins may be called petroleum plasticizing resins, or based on plant materials. In particular embodiments, although not limiting the invention, these resins may contain essentially only hydrogen and carbon atoms.

The plasticizing hydrocarbon resins useful in particular embodiment of the present invention include those that are homopolymers or copolymers of cyclopentadiene (CPD) or dicyclopentadiene (DCPD), homopolymers or copolymers of terpene, homopolymers or copolymers of C₅ cut and mixtures thereof.

Such copolymer plasticizing hydrocarbon resins as discussed generally above may include, for example, resins made up of copolymers of (D)CPD/vinyl-aromatic, of (D)CPD/terpene, of (D)CPD/C₅ cut, of terpene/vinyl-aromatic, of C₅ cut/vinyl-aromatic and of combinations thereof.

Terpene monomers useful for the terpene homopolymer and copolymer resins include alpha-pinene, beta-pinene and limonene. Particular embodiments include polymers of the limonene monomers that include three isomers: the L-limonene (levorotatory enantiomer), the D-limonene (dextrorotatory enantiomer), or even the dipentene, a racemic mixture of the dextrorotatory and laevorotatory enantiomers.

Examples of vinyl aromatic monomers include styrene, alpha-methylstyrene, ortho-, meta-, para-methylstyrene, vinyl-toluene, para-tertiobutylstyrene, methoxystyrenes, chloro-styrenes, vinyl-mesitylene, divinylbenzene, vinylnaphthalene, any vinyl-aromatic monomer coming from the C₉ cut (or, more generally, from a C₈ to C₁₀ cut). Particular embodiments that include a vinyl-aromatic copolymer include the vinyl-aromatic in the minority monomer, expressed in molar fraction, in the copolymer.

Particular embodiments of the present invention include as the plasticizing hydrocarbon resin the (D)CPD homopolymer resins, the (D)CPD/styrene copolymer resins, the polylimonene resins, the limonene/styrene copolymer resins, the limonene/D(CPD) copolymer resins, C₅ cut/styrene copolymer resins, C₅ cut/C₉ cut copolymer resins, and mixtures thereof.

Commercially available plasticizing resins that include terpene resins suitable for use in the present invention include a polyalphapinene resin marketed under the name Resin R2495 by Hercules Inc. of Wilmington, Del. Resin R2495 has a molecular weight of about 932, a softening point of about 135° C. and a glass transition temperature of about 91 ° C. Another commercially available product that may be used in the present invention includes DERCOLYTE L120 sold by the company DRT of France. DERCOLYTE L120 polyterpene-limonene resin has a number average molecular weight of about 625, a weight average molecular weight of about 1010, an Ip of about 1.6, a softening point of about 119° C. and has a glass transition temperature of about 72° C. Still another commercially available terpene resin that may be used in the present invention includes SYLVARES TR 7125 and/or SYLVARES TR 5147 polylimonene resin sold by the Arizona Chemical Company of Jacksonville, Fla. SYLVARES 7125 polylimonene resin has a molecular weight of about 1090, has a softening point of about 125° C., and has a glass transition temperature of about 73° C. while the SYLVARES TR 5147 has a molecular weight of about 945, a softening point of about 120° C. and has a glass transition temperature of about 71° C.

Other suitable plasticizing hydrocarbon resins that are commercially available include C₅ cut/vinyl-aromatic styrene copolymer, notably C₅ cut/styrene or C₅ cut/C₉ cut from Neville Chemical Company under the names SUPER NEVTAC 78, SUPER NEVTAC 85 and SUPER NEVTAC 99; from Goodyear Chemicals under the name WINGTACK EXTRA; from Kolon under names HIKOREZ T1095 and HIKOREZ T1100; and from Exxon under names ESCOREZ 2101 and ECR 373.

Yet other suitable plasticizing hydrocarbon resins that are limonene/styrene copolymer resins that are commercially available include DERCOLYTE TS 105 from DRT of France; and from Arizona Chemical Company under the name ZT115LT and ZT5100.

It may be noted that the glass transition temperatures of plasticizing resins may be measured by Differential Scanning Calorimetry (DCS) in accordance with ASTM D3418 (1999). In particular embodiments, useful resins may have a glass transition temperature that is at least 25° C. or alternatively, at least 40° C. or at least 60° C. or between 25° C. and 95° C., between 40° C. and 85° C. or between 60° C. and 80° C.

The amount of plasticizing hydrocarbon resin useful in any particular embodiment of the present invention depends upon the particular circumstances and the desired result. In general, for example, the plasticizing hydrocarbon resin may be present in the rubber composition in an amount of between 5 phr and 60 phr or alternatively, between 10 phr and 50 phr. In particular embodiments, the plasticizing hydrocarbon resin may be present in an amount of between 10 phr and 60 phr, between 15 phr and 55 phr or between 15 phr and 50 phr.

The rubber compositions disclosed herein may be cured with any suitable curing system including a peroxide curing system or a sulfur curing system. Particular embodiments are cured with a sulfur curing system that includes free sulfur and may further include, for example, one or more of accelerators, stearic acid and zinc oxide. Suitable free sulfur includes, for example, pulverized sulfur, rubber maker's sulfur, commercial sulfur, and insoluble sulfur. The amount of free sulfur included in the rubber composition is not limited and may range, for example, between 0.5 phr and 10 phr or alternatively between 0.5 phr and 5 phr or between 0.5 phr and 3 phr. Particular embodiments may include no free sulfur added in the curing system but instead include sulfur donors.

Accelerators are used to control the time and/or temperature required for vulcanization and to improve the properties of the cured rubber composition. Particular embodiments of the present invention include one or more accelerators. One example of a suitable primary accelerator useful in the present invention is a sulfenamide. Examples of suitable sulfenamide accelerators include n-cyclohexyl-2-benzothiazole sulfenamide (CBS), N-tert-butyl-2-benzothiazole Sulfenamide (TBBS), N-Oxydiethyl-2-benzthiazolsulfenamid (MBS) and N′-dicyclohexyl-2-benzothiazolesulfenamide (DCBS). Combinations of accelerators are often useful to improve the properties of the cured rubber composition and the particular embodiments include the addition of secondary accelerators.

Particular embodiments may include as a secondary accelerant the use of a moderately fast accelerator such as, for example, diphenylguanidine (DPG), triphenyl guanidine (TPG), diorthotolyl guanidine (DOTG), o-tolylbigaunide (OTBG) or hexamethylene tetramine (HMTA). Such accelerators may be added in an amount of up to 4 phr, between 0.5 and 3 phr, between 0.5 and 2.5 phr or between 1 and 2 phr. Particular embodiments may exclude the use of fast accelerators and/or ultra-fast accelerators such as, for example, the fast accelerators: disulfides and benzothiazoles; and the ultra-accelerators: thiurams, xanthates, dithiocarbamates and dithiophosphates.

Other additives can be added to the rubber compositions disclosed herein as known in the art. Such additives may include, for example, some or all of the following: antidegradants, antioxidants, fatty acids, waxes, stearic acid and zinc oxide. Examples of antidegradants and antioxidants include 6PPD, 77PD, IPPD and TMQ and may be added to rubber compositions in an amount, for example, of from 0.5 phr and 5 phr. Zinc oxide may be added in an amount, for example, of between 1 phr and 6 phr or alternatively, of between 1.5 phr and 4 phr. Waxes may be added in an amount, for example, of between 1 phr and 5 phr.

The rubber compositions that are embodiments of the present invention may be produced in suitable mixers, in a manner known to those having ordinary skill in the art, typically using two successive preparation phases, a first phase of thermo-mechanical working at high temperature, followed by a second phase of mechanical working at lower temperature.

The first phase of thermo-mechanical working (sometimes referred to as “non-productive” phase) is intended to mix thoroughly, by kneading, the various ingredients of the composition, with the exception of the vulcanization system. It is carried out in a suitable kneading device, such as an internal mixer or an extruder, until, under the action of the mechanical working and the high shearing imposed on the mixture, a maximum temperature generally between 120° C. and 190° C., more narrowly between 130° C. and 170° C., is reached.

After cooling of the mixture, a second phase of mechanical working is implemented at a lower temperature. Sometimes referred to as “productive” phase, this finishing phase consists of incorporating by mixing the vulcanization (or cross-linking) system (sulfur or other vulcanizing agent and accelerator(s)), in a suitable device, for example an open mill. It is performed for an appropriate time (typically between 1 and 30 minutes, for example between 2 and 10 minutes) and at a sufficiently low temperature lower than the vulcanization temperature of the mixture, so as to protect against premature vulcanization.

The rubber composition can be formed into useful articles, including treads for use on vehicle tires. The treads may be formed as tread bands that are later made a part of a tire or they be formed directly onto a tire carcass by, for example, extrusion and then cured in a mold. As such, tread bands may be cured before being disposed on a tire carcass or they may be cured after being disposed on the tire carcass. Typically a tire tread is cured in a known manner in a mold that molds the tread elements into the tread, including, e.g., the sipes molded into the tread blocks and or chamfers on the edges of the tread blocks, ribs or other tread elements and/or sipes.

It is recognized that treads may be formed from only one rubber composition or in two or more layers of differing rubber compositions, e.g., a cap and base construction. In a cap and base construction, the cap portion of the tread is made of one rubber composition that is designed for contact with the road. The cap is supported on the base portion of the tread, the base portion made of a different rubber composition. In particular embodiments of the present invention the entire tread may be made from the rubber compositions as disclosed herein while in other embodiments only the cap portions of the tread may be made from such rubber compositions.

It is recognized that the contact surface of a tread block, i.e, that portion of the tread block that contacts the road, may be formed totally from the rubber composition having the low modulus as disclosed herein, may be formed totally from another rubber composition or may be formed as combinations thereof. For example, a tread block may be formed as a composite of layered rubber compositions such that half of the block laterally is a layer of the low modulus rubber composition and the other half of the block laterally is a layer of an alternative composition. Such construction would provide a tread block having at least 80 percent of its contact surface formed of the low modulus rubber composition.

As such, in particular embodiments of the present invention, at least 80 percent of the total contact surface of all the tread blocks on a tread may be formed form the rubber composition having the low modulus rubber composition as disclosed herein. Alternatively, at least 85 percent, at least 90 percent, at least 95 percent or 100 percent of the total contact surface of all the tread blocks on a tread may be formed from such a rubber composition.

While the tire treads disclosed herein are suitable for many types of vehicles, particular embodiments include tire treads for use on vehicles such as passenger cars and/or light trucks. Such tire treads are also useful for all-season tires and/or snow tires.

Particular embodiments of the present invention may further include methods for designing and manufacturing the tires and treads as disclosed herein. Such methods may include the steps of designing one tread elements such as a block or rib with edges that are chamfered. By chamfered, it is to be understood that a flat or filleted geometry could be used or any other suitable geometry that causes a decrease locally of the pressure during a braking event. It may further include that creation of a such a chamfered areas on a number of tread elements exceed some minimum threshold such as a chamfer density of 15%. It may also include the step of creating a tread using a rubber composition of a suitably low modulus that is found on at least 80% of the contact surface of the tread elements. Finally, it may also comprise specifying a rubber composition for forming said tread elements such as tread blocks, wherein the rubber composition is based on a diene elastomer, a plasticizing system and a cross-linking system, wherein the rubber composition has complex shear modulus at 60° C. of less than 1 MPa, and more preferably about 0.8 MPa, and may further include mixing and/or curing such a rubber composition.

Particular embodiments of such methods may further include forming a tread with the determined chamfer density and specified rubber composition. Other steps may include designing or designating that the tread elements have a contact surface that is made entirely of the specified rubber composition or alternatively, at least 90 percent of the contact surface area is made entirely of the specified rubber composition.

The step of forming the tread may further include molding the tread or extruding the tread.

The invention is further illustrated by the following examples, which are to be regarded only as illustrations and not delimitative of the invention in any way. The properties of the compositions disclosed in the examples were evaluated as described below and these utilized methods are suitable for measurement of the claimed properties of the present invention.

Modulus of elongation (MPa) was measured at 10% (MA10) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

Shore A hardness of the compositions after curing was assessed in accordance with ASTM Standard D 2240-86.

The maximum tan delta dynamic properties for the rubber compositions were measured at 23° C. on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress at a frequency of 10 Hz under a controlled temperature of 23° C. Scanning was effected at an amplitude of deformation of 0.05 to 50% (outward cycle) and then of 50% to 0.05% (return cycle). The maximum value of the tangent of loss angle delta (max tan δ) was determined during the return cycle.

Dynamic characteristics of the rubber compositions (Tg and G*) were measured on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternation single sinusoidal shearing stress of constant 0.7 MPa and at a frequency of 10 Hz over a temperature sweep from −60° C. to 100° C. with the temperature increasing at a rate of 1.5° C./min. The shear modulus G* at 60° C. was captured and the temperature at which the max tan delta occurred was recorded as the glass transition temperature, Tg.

### EXAMPLE 1

Rubber compositions were prepared using the components shown in Table 1. The amount of each component making up the rubber compositions shown in Table 1 are provided in parts per hundred parts of rubber by weight (phr). The SBR was an oil extended rubber (with 10 phr MES) having a Tg of −27° C. and the BR had a Tg of −104° C.

The terpene resin was SYLVARES TR-5147, a polylimonene resin available from Arizona Chemical, Savannah, Ga. The plasticizing oil was napthenic oilr and/or sunflower oil. The silica was ZEOSIL 160, a highly dispersible silica available from Rhodia having a BET of 160 m²/g. The silane coupling agent was X 50-S available from Evonik Degussa. The curative package included sulfur, accelerators, zinc oxide and stearic acis.

The rubber formulations were prepared by mixing the components given in Table 1, except for the sulfur and the accelerators, in a Banbury mixer operating at 25-65 RPM until a temperature of between 130° C. and 170° C. was reached. The accelerators and sulfur were added in the second phase on a mill. Vulcanization was effected at 150° C. for 40 minutes. The formulations were then tested to measure their physical properties, which are also included in the lower portion of table 1.

The second formulation F2 has a Tg of −14° C. that may typically be suitable for a summer tire. The first formulation F1 has a Tg of −21° C. that may typically be suitable for an all season tire. The third formulation F3 has a Tg of −31, a low Tg typically used for a winter tire. The amount of plasticizing oils and resin were adjusted to maintain a fairly constant modulus while adjusting the Tg of the rubber compositions.

The inventors of the present invention are currently planning to test tires to validate the performance predicted by models. The predictions indicate that using a suitably soft material with a chamfer density above a critical value, as discussed previously will result in improved wet traction while not substantially affecting snow traction in a negative manner.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A tread for a tire, the tread comprising:
one or more repeating pitches, each repeating pitch comprising tread elements, said tread elements being defined by one or more lateral grooves, said tread elements further comprising leading and trailing edges adjacent said lateral grooves and adjacent sipes found within the tread elements;
wherein the tread has a weighted average Chamfer Density (CD_{w}) of at least 15%, wherein a chamfer density (CD) for each of the one or more repeating pitches is:
$$CD = \frac{TPLCE}{TPLE} ,$$
where, for one repeating pitch, TPLCE is total projected length of the chamfered edges of the one repeating pitch, TPLE is the total projected length of the lateral edges of the one repeating pitch, and
wherein the tread elements comprise a rubber composition based upon a diene elastomer, a plasticizing system and a cross-linking system, wherein the rubber composition has a shear modulus G* measured at 60° C. of less than 1.0 MPa.

2. The tread of claim 1, wherein the rubber composition also has a glass transition temperature of between −40° C. and −15° C.

3. The tread of claim 1, wherein there are between 2 and 5 different repeating pitches.

4. The tread of claim 3, wherein the individual pitches from each of the repeating pitches alternate in a pattern along the entire tire tread.

5. The tread of claim 1, wherein the chamfered edges are filleted or rounded.

6. The tread of claim 1, wherein the shear modulus G* measured at 60° C. of between 0.5 MPa and 0.9 MPa.

7. The tread of claim 1, wherein CD_{w} is between 80% and 100%.

8. The tread of claim 7, wherein CD_{w} is about 90%.

9. The tread of claim 1, wherein the tread elements are tread blocks.

10. The tread of claim 1, wherein the shear modulus G* is between 0.75 MPa and 0.85 MPa.

11. The tread of claim 1, wherein the diene elastomer is selected from natural rubber, styrene-butadiene rubber, synthetic polyisoprene rubber, polybutadiene rubber and combinations thereof.

12. The tread of claim 1, wherein the plasticizing system comprises plasticizers selected from a plasticizing oil, a plasticizing resin or combinations thereof.

13. The tread of claim 11, wherein the plasticizing resin is a polylimonene resin.

14. The tread of claim 11, wherein the plasticizing oil is selected from a petroleum based oil, a vegetable oil or combinations thereof.

15. The tread of claim 1, further comprising:
additional tread elements formed in one or more of the individual pitches, the additional tread blocks comprising a second rubber composition, wherein at least 80 percent of a total contact surface of all the tread elements on the tread are formed from the first rubber composition.

16. The tread of claim 1, wherein the tread elements further comprise a second rubber composition, wherein at least 80 percent of a total contact surface of all the tread elements on the tread are formed from the first rubber composition.

17. The tread of claim 1, wherein the tire is selected from a passenger vehicle tire or a light truck tire.

18. A tread for a tire, the tread comprising:
one or more repeating pitches, each repeating pitch comprising tread elements, said tread elements being defined by one or more lateral grooves, said tread elements further comprising leading and trailing edges adjacent said lateral grooves and wherein the tread elements have a contact surface adapted for contacting a road and sipes found within the tread elements;
wherein the tread has a weighted average Chamfer Density (CD_{w}) of at least 15%, wherein a chamfer density (CD) for each of the one or more repeating pitches is:
$$CD = \frac{TPLCE}{TPLE} ,$$
where, for one repeating pitch, TPLCE is total projected length of the chamfer edges of the one repeating pitch, TPLE is the total projected length of the lateral edges of the one repeating pitch, and
wherein the contact surface of the tread elements comprises a rubber composition based upon a diene elastomer, a plasticizing system and a cross-linking system, wherein the rubber composition has a shear modulus G* measured at 60° C. of less than 1.0 MPa.

19. The tread of claim 18, wherein the contact surface is made entirely of the rubber composition.

20. The tread of claim 18, wherein at least 90 percent of the contact surface is made entirely of the rubber composition.
